(19) United States
(12) Patent Application Publication
(10) Pub. No.: US 2025/0342738 A1
(43) Pub. Date: Nov. 6, 2025

(54) Control System for a Motor Vehicle

(71) Applicant: Bayerische Motoren Werke Aktiengesellschaft, Muenchen (DE)

(72) Inventors: Michael FURCHNER, Mering (DE); Marco HIPPLER, Muenchen (DE); Thorsten KNOTT, Tuntenhausen (DE); Daniel KUELZER, Muenchen (DE); Lukas REINHART, Freising (DE)

(21) Appl. No.: 19/192,477

(22) Filed: Apr. 29, 2025

(30) Foreign Application Priority Data
May 6, 2024 (DE) 102024 112712.0

(51) Int. Cl. G07C 9/00; B60R 25/04; B60R 25/20

(52) U.S. Cl. CPC G07C 9/00817; B60R 25/04; B60R 25/209

(57) ABSTRACT

A method of controlling a motor vehicle includes detecting, by a key management system, a request to set up a locking device against addition of a newly generated digital vehicle key which can be used to control the motor vehicle, storing, by the key management system, a request for setting up a locking device in a digital vehicle key which has been stored on a mobile device, transmitting the request from the mobile device to the motor vehicle and setting up the locking device on the part of the motor vehicle.

### CROSS REFERENCE TO RELATED APPLICATION

This application claims priority under 35 U.S.C. § 119 from German Patent Application No. 10 2024 112 712.0, filed May 6, 2024, the entire disclosure of which is herein expressly incorporated by reference.

### BACKGROUND AND SUMMARY

The present invention relates to the control system for a motor vehicle by means of a digital vehicle key. In particular, the invention hereby relates to the addition of a newly generated digital vehicle key.

A motor vehicle comprises a control device, which is set up to control a predetermined security function of the motor vehicle based on a digital vehicle key. A digital vehicle key is stored on the control device, to which an authorization to control a security function is assigned. In particular, the security function can comprise a central locking or an immobilizer. Another part of the digital vehicle key can be stored on a user's device. The user can show their digital vehicle key wirelessly at the motor vehicle to control the security function.

A new vehicle key can be added to the system by generating the key and then presenting it to a key management system, which signs it and stores it on the motor vehicle. The process of generating and/or adding a newly generated digital vehicle key represents a possible attack vector on the security concept. To be able to protect against this, a locking device can be set up on the motor vehicle so that the motor vehicle does not accept any newly generated digital vehicle keys for the storage. The locking device can be set up directly on the motor vehicle or, alternatively, a request to set up a locking device can be transmitted wirelessly to the motor vehicle. If a wireless connection cannot be set up, for example, because the motor vehicle is shielded from radio waves in an underground car park, then the request cannot be received and the locking device cannot be set up.

An underlying task of the present invention is to provide an improved technology for securing a motor vehicle by means of a digital vehicle key. The invention solves this task by means of the objects of the independent claims. The dependent claims indicate preferred embodiments.

It has been recognized that communication between a motor vehicle, which can be controlled by means of a wireless key, as well as a key management system can be set up by transmitting a message in a digital key which can be stored on a mobile device.

The mobile device can be moved around independently of the motor vehicle, so that a radio shadow around the motor vehicle can only thereby apply to the mobile device temporarily. For example, the key can be used to issue a request to set up or unlock a locking device, which means that a newly generated vehicle key cannot be used to control the motor vehicle. Information can be transmitted or stored in encrypted form to ensure system security.

The inventive concept can be expressed in various methods, various control system devices for a motor vehicle and various key management systems. Furthermore, the invention can be implemented on a motor vehicle or a system comprising at least one motor vehicle.

A method, a control device for a motor vehicle and a key management system are hereby proposed for setting up a locking device.

A method for controlling a motor vehicle comprises the steps of detecting, by a key management system, a request for setting up a locking device against the addition of a newly generated digital vehicle key which can be used to control the motor vehicle; storing, by the key management system, a request for setting up a locking device in a digital vehicle key which is stored on a mobile device; transmitting the request from the mobile device to the motor vehicle and setting up a locking device on the part of the motor vehicle.

The digital vehicle key can be particularly designed according to the proposals of the Car Connectivity Consortium. A technical specification of the underlying technology has been previously published. The locking device on the part of the motor vehicle can have the effect that an attestation package for a newly generated digital vehicle key is not accepted by the motor vehicle.

The request is preferably only stored in the vehicle key when direct communication between the key management system and the motor vehicle is deemed to be not successful. If communication is not successful for a predetermined period of a few seconds or minutes, for example, then transmission by key can be used instead. Optionally, an attempt can also be implemented to transmit the request directly from the key management system to the motor vehicle.

The request can be stored in a mailbox of the vehicle key. The vehicle key can support a private mailbox function and/or a confidential mailbox function, wherein the private mailbox cannot be assigned for a specific purpose and is therefore considered to be the preferred method. Information is stored in encrypted form in both cases and, preferably, the request is encrypted in such a way that only the recipient and optionally the transmitter can decrypt the message. A stored message can also be cryptographically signed so that an unnoticed amendment is impossible.

A locking device can be set up by the key management system in response to the request which has been received. The locking device of the key management system can mean that no attestation package is provided to the motor vehicle for a newly generated digital key. Locking devices on the part of the key management system, as well as on the part of the motor vehicle, can act independently of each other and thereby prevent the addition of a new vehicle key on their own.

A control system device for a motor vehicle comprises means for communicating with a mobile device on which a digital vehicle key for the motor vehicle is stored, as well as processing means. The processing device is therefore adapted to read a request stored in the vehicle key which is addressed to the motor vehicle by a key management system, wherein the request hereby relates to the setting up of a locking device against the addition of a newly generated digital vehicle key which can be used to control the motor vehicle and to set up the requested locking device.

A key management system for digital vehicle keys for a motor vehicle comprises a device for communicating with a mobile device on which a digital vehicle key for the motor vehicle has been stored and processing device. The processing device is hereby adapted to read a request, which will be stored in the vehicle key and directed from the motor vehicle to the key management device, wherein the request concerns setting up a locking device against the addition of a newly generated digital vehicle key which can be used to control the motor vehicle and to set up the requested locking device.

Locking devices that have been set up can be disabled in a concerted manner by also transmitting information via a digital vehicle key whenever required. A method, a control system device for a motor vehicle and a key management system are proposed for disabling a locking device.

A method of controlling a motor vehicle comprising the steps of detecting, by a motor vehicle, a request to unlock a locking device against an addition of a newly generated digital vehicle key which can be used to control the motor vehicle; determining, in the area of the motor vehicle, a mobile device on which a digital vehicle key for the motor vehicle is stored; storing, by the motor vehicle, a request directed from the motor vehicle to a key management system in the digital vehicle key, wherein the request concerns an disabling of a locking device. Transmitting the request from the mobile device to the key management system and disabling a corresponding locking device on the part of the key management system.

The request is preferably only stored in the vehicle key when any direct communication between the motor vehicle and the key management system is unsuccessful. The request can be stored in a mailbox located on the vehicle key, in a private mailbox. Additional degrees of freedom are described above in respect of the transmission of a request to set up a locking device.

Another preferred method is to disable an existing locking device on the part of the motor vehicle in response to the received request, wherein the locking device prevents the processing of an attestation package for a newly generated digital vehicle key. If there is no corresponding locking device, then the attestation package is therefore generated by the key management system and provided to the motor vehicle. A newly generated digital vehicle key can only be used to control the motor vehicle after the attestation package has been evaluated by the motor vehicle. The vehicle can deny the acceptance or processing of an attestation package due to the locking device on the part of the motor vehicle.

A control system device for a motor vehicle comprises a device for communicating with a mobile device on which a digital vehicle key for the motor vehicle is stored and a processing device. The processing device has been adapted to store, in the digital vehicle key, a request directed from the motor vehicle to a key management system, wherein the request therefore relates to an unlocking of a locking device against an addition of a newly generated digital vehicle key which can be used to control the motor vehicle.

A key management system for digital vehicle keys for a motor vehicle comprises the device for communicating with a mobile device on which a digital vehicle key for the motor vehicle is stored. Processing methods which have been adapted to read a request stored in the vehicle key and directed from the motor vehicle to the key management system, wherein the request therefore concerns the unlocking of a locking device against the addition of a newly generated digital vehicle key which can be used to control the motor vehicle and to unlock the requested locking device.

Furthermore, a motor vehicle is hereby proposed which comprises one of the control system devices which have been described herein. In particular, the motor vehicle can comprise a passenger car. Furthermore, a system is therefore proposed which comprises a minimum of one motor vehicle hereby described and a key management system described herein.

A control device which is hereby described and a key management device described herein can each be adapted to partially or fully execute a method hereby described. For this purpose, a processing device can be used, which is preferably of electronic design and comprises, for example, an integrated circuit, a programmable logic module or a programmable microcomputer. The method can therefore be implemented in the form of a configuration and/or as a computer program product with program code methods for the processing device. The configuration or computer program product can be stored on a computer-readable data carrier. Features or advantages of the method can subsequently be transferred to the device or vice versa.

The invention will now be described in more detail with reference to the accompanying technical drawings, in which:

### BRIEF DESCRIPTION OF THE DRAWINGS

FIG. 1 illustrates a system;

FIG. 2 illustrates a flow chart of a process;

FIG. 3 illustrates a flow chart of another method; and

FIG. 4 illustrates a flow chart of yet another process.

### DETAILED DESCRIPTION OF THE DRAWINGS

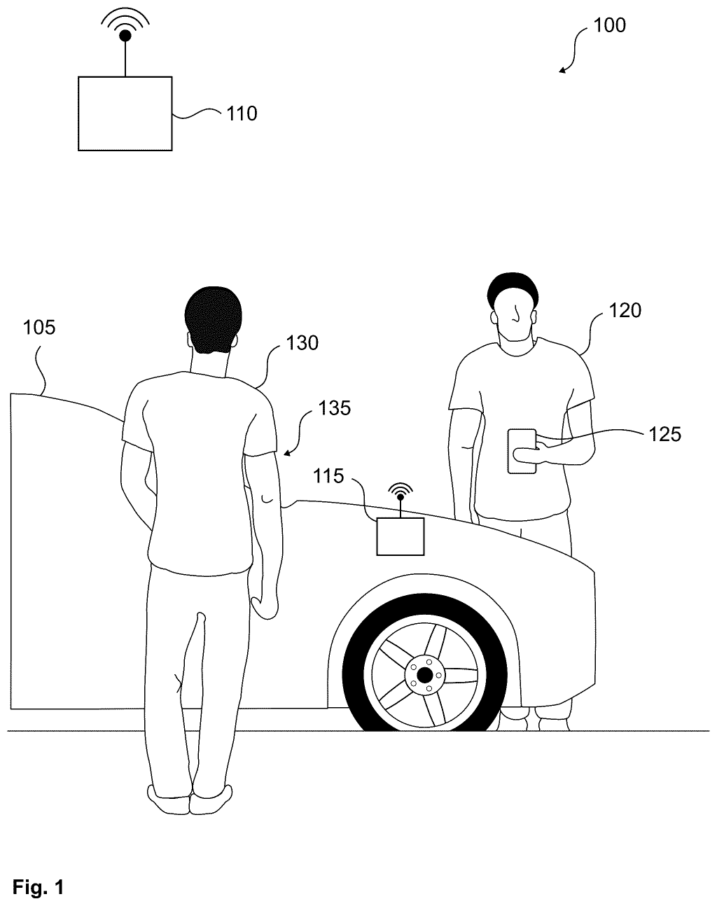

FIG. 1 illustrates a system 100 with a motor vehicle 105 and a key management system 110. The motor vehicle 105 comprises a control system device 115 which is configured to control a predetermined function of the motor vehicle 105, a security function, based on a digital vehicle key. The security function can, for example, comprise unlocking a vehicle door or vehicle flap on the motor vehicle 105, thereby deactivating an immobilizer or activating a drive motor.

The underlying concept of the digital vehicle key hereby preferably follows the suggestions of the Car Connectivity Consortium (CCC). In simplified terms, a specific digital vehicle key is therefore associated with a first person 120 and is typically stored on the first mobile device 125 which is associated with the first person 120. The digital vehicle key is additionally stored on the control system device 115 in the motor vehicle 105. Controlling the security function of the motor vehicle 105 requires a cryptographic exchange between the control system device 115 and the mobile device 125. Preferably, an asymmetric cryptographic method is thereby used to authenticate one of the communication partners. The digital vehicle key can comprise a private part, which is stored on the mobile device 125 and a public part, which is stored on the control system device 115.

Conversely, a public key which is located on the control system device 115 can be known by the first mobile device 125, the corresponding private key of which is only known by the control device 115. In a so-called standard transaction, mutual authentication of the first mobile device 125 and the control system device 115 can be executed. To make his digital key accessible in the first mobile device 125, the person 120 can authenticate themselves to the first mobile device 125 beforehand, for example, by presenting a biometric feature or by entering a predetermined secret text.

A new digital vehicle key can be generated and assigned to a second person 130 who is assigned a second mobile device 135 for this purpose. By way of example, it is hereby assumed that the first person 120 is an owner of the motor vehicle 105 and that the digital vehicle key assigned to them thereby authorizes them to issue or sign a newly generated vehicle key. The second person 120 is usually referred to as a friend or acquaintance in this case.

The generation process can include the key management system 110 digitally signing a newly generated digital vehicle key and generating an attestation package comprising the signed key and depositing this attestation package with the motor vehicle 105 or the control system device 115.

It is proposed to selectively inhibit the addition of a newly generated digital vehicle key to a stock of valid digital vehicle keys, which can be used to control the motor vehicle 105, or to release them again. It is particularly preferred that a locking device for preventing the addition of a newly generated vehicle key is to be set up or unlocked on the part of the motor vehicle 105 or the control system device 115 and/or also on the part of the key management system 110.

Optionally, a device 140 can be provided via which a request can be implemented directly to the key management system 110 to set up a locking device. The device 140 can be equipped with its own digital vehicle key, with which the request can be generated. Access to device 140 can be restricted in any way. For example, a person 120 or 130 who is wishing to set or unlock a locking device can thereby state their legal position which is legitimizing them to take this step. Their request can be reviewed by another person or also automatically by the device 140.

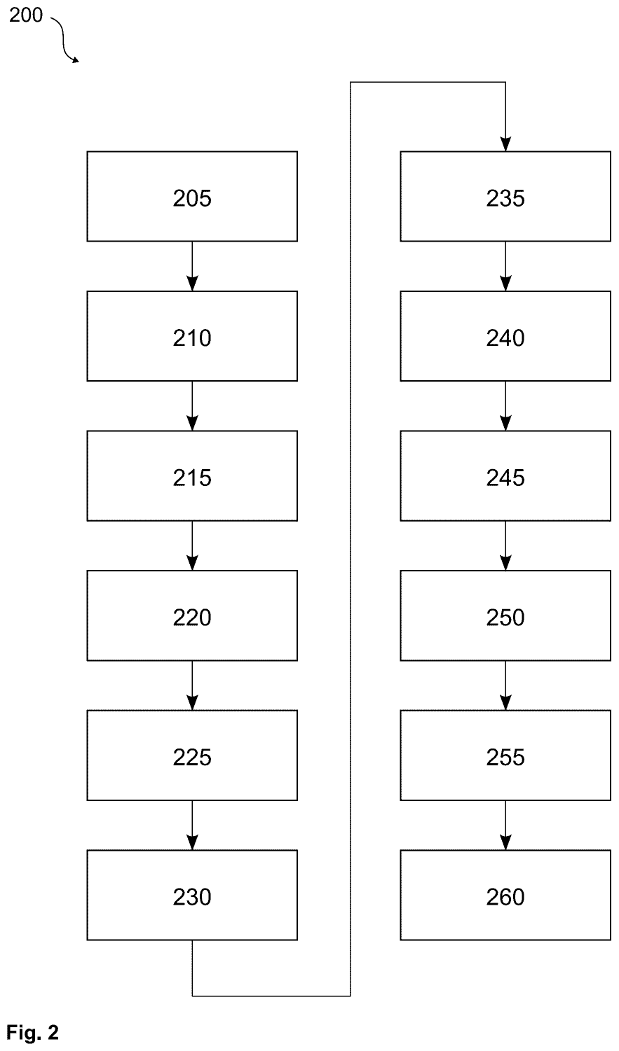

FIG. 2 illustrates a flowchart for a method 200 for exiting or participating in a key generation process for a motor vehicle 105. Exiting corresponds to setting up at least one locking device and participating corresponds to disabling all locking devices.

In Step 205, it is assumed that the motor vehicle 105 is in an initial status with respect to its control system by means of a digital vehicle key. This status can be assumed when the motor vehicle 105 is handed over by the manufacturer to its initial, registered owner.

In Step 210, an owner key can be generated. This is a digital vehicle key to which the authorization to generate or sign a newly generated vehicle key is usually assigned. In other words, the first person 120, in their role as owner, can thereby generate or cryptographically sign additional digital vehicle keys with the vehicle key assigned to them.

In Step 215, additional keys can be generated, for example, for the second person 130. If the stock of digital vehicle keys that can be used to control the motor vehicle 105 fulfils the expectations of the first person 120, then the first person 120 can initiate a request to opt out of the addition of new vehicle keys. To do so, the first person 120 can transmit a corresponding message to the control system device 115 by using their first mobile device 125 and the digital vehicle key stored thereon.

In Step 225, the control system device 115 can review whether a received request includes an authorization to exit the motor vehicle. It can be reviewed whether this authorization is assigned to the digital vehicle key based on which the request was generated. Authorizations of a digital vehicle key are generally defined before the vehicle key is generated or cryptographically signed.

In Step 230, it can be reviewed whether there is at least one digital vehicle key in a stock of valid digital vehicle keys for the motor vehicle 105, based on which a subsequent participation in an addition of a newly generated digital vehicle key can be controlled. In other words, before setting up a locking device against the addition of a newly generated digital vehicle key for the motor vehicle 105, it is possible to review whether predetermined conditions are fulfilled to unlock the locking device subsequently again.

In Step 235, a corresponding locking device can be set up on the motor vehicle 105 or on the control system device 115. In particular, the locking device can prevent an attestation package for a newly generated digital vehicle key for the motor vehicle 105 from being accepted or the digital vehicle key contained therein from being stored.

In Step 240, a message can be transmitted from the motor vehicle 105 to the key management system to instruct the key management system to also set up a locking device against the addition of a digital vehicle key for the motor vehicle 105. This locking device can have the effect that a key signing request for a digital vehicle key or a key tracking request for the motor vehicle 105 is not fulfilled. In addition, an information package relating to a newly generated digital vehicle key can be prevented from being transmitted to the motor vehicle 105 or the control system device 115.

Adding a newly generated digital vehicle key to the stock of valid vehicle keys for vehicle 105 is already prevented when only one of the locking devices is set up. However, existing digital vehicle keys stored in the stock can continue to be used. Optionally, a digital vehicle key from the stock can also be declared invalid while one of the locking devices is active. In this case, it is preferable to ensure that there is always a minimum of one digital vehicle key stored in the stock which can be used to unlock the locking device.

An existing locking device on the part of the motor vehicle 105 and/or on the part of the key management system 110 can remain in place indefinitely. Optionally, a path is provided to unlock a locking device again. A digital vehicle key can be used for this purpose, to which a corresponding authorization can be assigned.

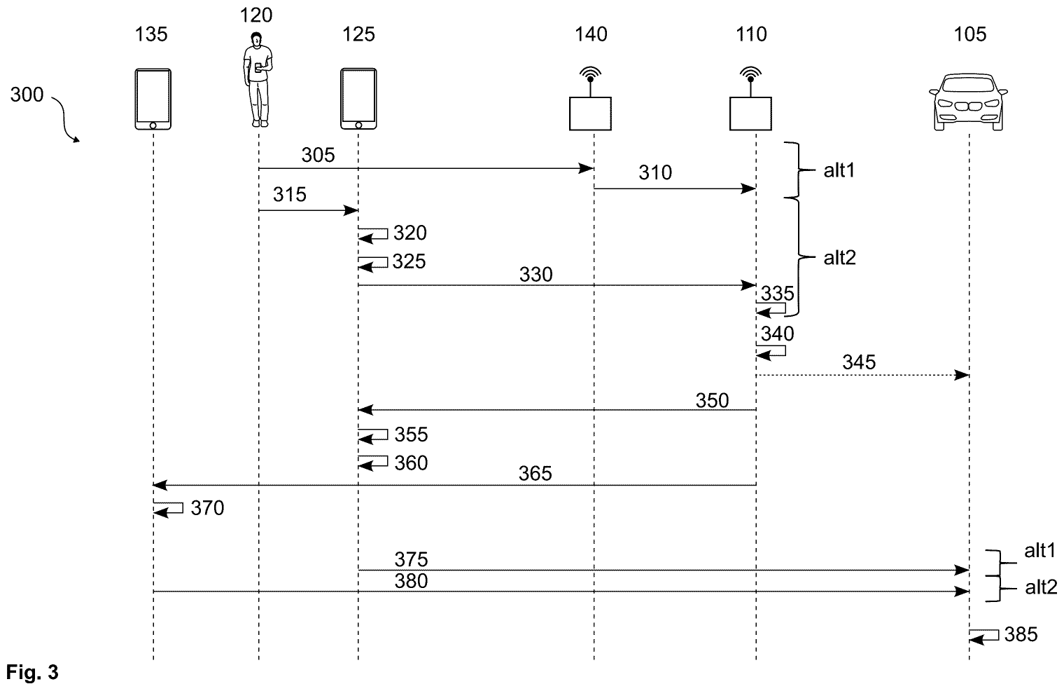

FIG. 3 illustrates a flowchart for method 300 for setting up a locking device against the addition of a newly generated vehicle key for the motor vehicle 105. At the beginning of method 300, all participants 105, 110, 120, 125, 135 can be informed that a new digital vehicle key can be generated and made operable to control the motor vehicle 105.

In Step 205, a person 120 can request the setting up of a locking device via device 140. For this purpose, person 120 can legitimize and/or authenticate themself to device 140. If the request is successfully reviewed, then a request to set up a locking device can be transmitted to the key management system 110 in Step 310.

In Step 315, the person 120 can make an entry on a mobile device 125 to cause a locking device to be set. In Step 320, the person 120 can authenticate themselves. Optionally, they can reconfirm their input to prevent unintentional blocking. In Step 325, a request to set a locking device can be generated based on a digital vehicle key which has been stored on the mobile device 125 from person 110. The request can be transmitted to the key management system 110 in Step 330. In Step 335, the key management system 110 can set up the locking device.

Following Step 310 or Step 335, the key management system 110 can review the request based on the digital vehicle key which had been used to generate it. If the review is successful, then a request to set up a locking device can be transmitted in Step 340 to the motor vehicle 105, which can set up the locking device in Step 345. If Step 345 fails because a communication link between the key management system 110 and the motor vehicle 105 is temporarily not possible, then method 300 can still be continued.

In Step 350, an indication of a set locking device can be sent from the key management system 110 to the mobile device 125 of the person 110. Furthermore, a request directed to the motor vehicle 105 can be transmitted to the mobile device 125, wherein the request concerns setting a locking device on the part of the motor vehicle 105. The request can be stored in a mailbox of the digital vehicle key of the owner 120.

In Step 355, the mobile device 110 can adapt a user interface for the person 110 in such a way that the set locking device is recognizable or that setting a locking device is no longer offered. In addition, in Step 330, sharing of an existing key with another person 130 can be prevented.

Similarly, an indication of the set locking device can optionally be transmitted from the key management system 110 to a mobile device 135 in Step 365. The mobile device 135 is assigned to a person 130 who is not the owner of the motor vehicle 105 or whose digital vehicle key does not have the authorization to sign a newly generated vehicle key. In Step 370, sharing of an existing vehicle key for the person 130 can be prevented. Furthermore, a request directed to the motor vehicle 105 can be transmitted to the mobile device 135, wherein the request relates to the setting up of a locking device on the part of the motor vehicle 105. The request can be stored in a mailbox of the digital vehicle key of the person 130.

In Step 375, the request to set up a locking device can be transmitted from the mobile device 125 to the motor vehicle 105 as soon as communication between the mobile device 125 of the owner 120 and the motor vehicle 105 is possible. Similarly, in Step 375, the request to set up a locking device can be transmitted from the mobile device 135 to the motor vehicle 105 as soon as communication between the mobile device 135 of the friend 130 and the motor vehicle 105 is possible. Steps 375 and 380 are illustrated as alternatives in FIG. 3, although the present technique also works when a request is transmitted multiple times.

In Step 385, the motor vehicle can review a received request and, if the review is successful, set up the requested locking device locally.

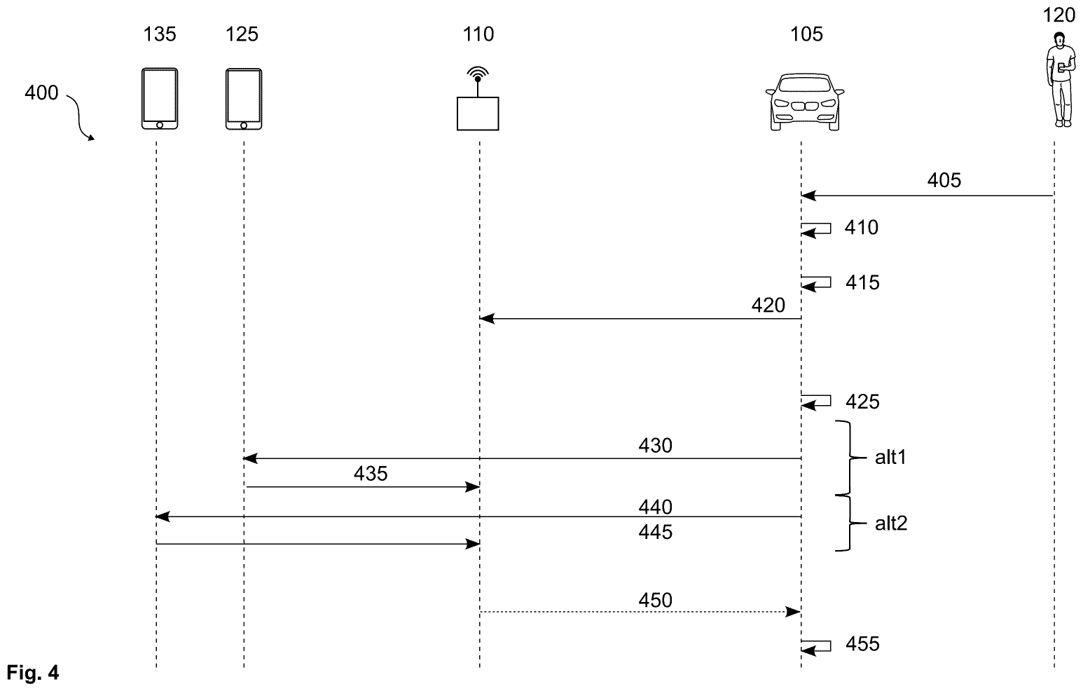

FIG. 4 illustrates a flowchart for an additional method 400 for disabling a locking device against the addition of a newly generated digital vehicle key for a motor vehicle 105. In one embodiment, a counter is provided on the part of the motor vehicle 105 and on the part of the key management system 110, the counter reading of which can be increased when a locking device is set up. At the beginning of the method, it is assumed that the counter readings of counters of the motor vehicle 105 and the key management system 110 thereby correspond to each other.

In Step 405, the person 120 submits an input to the motor vehicle 105 to unlock a locking device. In Step 410, the motor vehicle 105 reviews the presence of a mobile device 125 around the motor vehicle 105 and determines that a digital vehicle key which has been stored thereon is authorized to set a locking device. If the review is successful, then a locking device can be set by the motor vehicle 105 in Step 420 and the local counter reading can be increased.

The increased counter reading can be transmitted to the key management system 110 in Step 420 together with a request to set up a locking device. If this step is successful, then the process can continue in a conventional manner.

However, if direct communication with the key management system 110 is not possible, then a request to unlock the locking device can be generated by the key management system in Step 425.

In Step 430, the request together with the current counter reading can be transmitted to the mobile device 125 of the owner 120. Preferably, this transmission occurs as soon as the mobile device 125 is within communication range of the motor vehicle 105. Both pieces of information can be stored in a mailbox of a digital vehicle key of the owner 120, which is thereby stored on the mobile device 125.

In Step 435, the request can be transmitted from the mobile device 125 to the key management system 110. For this purpose, it is possible to wait until a communication connection between the mobile device 125 and the key management system 110 can be set up.

In a corresponding manner, in Step 440, the request together with the current counter reading can be transmitted to the mobile device 135 of the person 120. This transmission is preferably executed as soon as the mobile device 135 is within communication range of the motor vehicle 105. Both pieces of information can be stored in a mailbox of a digital vehicle key of the owner 120, which is stored on the mobile device 125.

In Step 445, the request can be transmitted from the mobile device 125 to the key management system 110. For this purpose, it is possible to wait until a communication connection can be set up between the mobile device 135 and the key management system 110.

Steps 430, 435 are illustrated as an alternative to Steps 440, 445; however, a technique described therein also functions when multiple paths are followed in parallel.

In Step 455, the motor vehicle 105 can review a received request. If the review is successful, then a locking device can be set locally on the motor vehicle 105. In addition, the local counter can be increased to the received countered reading of the key management system 110. The counters of the key management system and the motor vehicle 105 are therefore synchronized with each other again.

### LIST OF REFERENCE SYMBOLS

100 System
105 Motor vehicle
110 Key management
115 Control device
120 First person
125 First mobile device
130 Second person
135 Second mobile device
100 System
105 Motor vehicle
110 Key management
115 Control device
120 First person (owner)
125 First mobile device
130 Second person (friend)
135 Second mobile device
140 Device
200 Procedure
205 Motor vehicle new
210 Generating owner key
215 Generating additional key if necessary
220 Entering a request to exit
225 Request justified?
230 Vehicle key for participation exists?
235 Locking vehicle
240 Lock key management
245 Entering a request to participate, review authorization
250 Releasing vehicle
255 Enabling key management
260 Synchronizing
300 Procedure
305 Generating request for locking device
310 Request to set up a locking device (proprietary message)
315 Input: Set locking device
320 Confirmation and authentication of the person
325 Generating request to set up a locking device
330 Submitting request
335 Reviewing request
340 Transmitting request to set a locking device
345 Setting locking device
350 Transmitting reference to set locking device
355 Deactivating control element for setting a locking device
360 Sharing keys not possible
365 Transmitting reference to set locking device
370 Sharing keys not possible
375 Transmitting request to set up a locking device on next contact to motor vehicle
370 Transmitting request to set up a locking device on next contact to motor vehicle
385 Reviewing request, set up locking device
400 Procedure
405 Input: Remove locking device
410 Reviewing presence and authorization of a digital key
415 Disabling locking device, increasing counter reading, counter unsynchronized
420 Submitting request and counter reading
425 Generate request to unlock a locking device, enclose counter reading
430 Transmitting a request to unlock a locking device to an owner's mobile device
435 Managing key with Send request for disabling to key management
440 Sending a request to unlock a locking device to a friend's mobile device
445 Transmitting request for disabling to key management
450 Increasing counter reading, send confirmation with counter reading
455 Vehicle locked, counter synchronized

What is claimed is:

1. A method of controlling a motor vehicle, the method comprising:
detecting, by a key manager, a request to set up a locking device against addition of a newly generated digital vehicle key that can be used to control the motor vehicle;
storing, by the key management system, a request to set up the locking device in a digital vehicle key stored on a mobile device;
transmitting the request from the mobile device to the motor vehicle; and
setting up a barrier of the motor vehicle.

2. The method according to claim 1, wherein the request is only stored in the digital vehicle key when direct communication between the key management system and the motor vehicle is unsuccessful.

3. The method according to claim 1, wherein the request is stored in a mailbox of the digital vehicle key.

4. The method according to claim 2, wherein the request is stored in a mailbox of the digital vehicle key.

5. The method according to claim 1, wherein the locking device is set up by the key management in response to the request so that no attestation package is provided to the motor vehicle for a newly generated digital vehicle key.

6. The method according to claim 2, wherein the locking device is set up by the key management in response to the request so that no attestation package is provided to the motor vehicle for a newly generated digital vehicle key.

7. A control device for a motor vehicle, the control device comprising:
a device for communicating with a mobile device on which a digital vehicle key for the motor vehicle is stored; and
a processing device configured to read a request stored in the digital vehicle key which is addressed to the motor vehicle by a key management system;
wherein the request relates to setting up a locking device against addition of a newly generated digital vehicle key which can be used to control the motor vehicle and to set up the requested locking device.

8. A key management system for digital vehicle keys for a motor vehicle, the key management system comprising:
a device for communicating with a mobile device on which a digital vehicle key for the motor vehicle is stored; and
a processing device configured to read a request stored in the digital vehicle key which is directed from the motor vehicle to the key management system;
wherein the request relates to setting up a locking device against addition of a newly generated digital vehicle key which can be used to control the motor vehicle and to set up the requested locking device.

9. A method for controlling a motor vehicle, the method comprising:
detecting, by the motor vehicle, a request to unlock a locking device against addition of a newly generated digital vehicle key which can be used to control the motor vehicle;
determining a mobile device, on which a digital vehicle key for the motor vehicle is stored, around the motor vehicle;
storing, by the motor vehicle, a request addressed by the motor vehicle to a key management system in the digital vehicle key, wherein the request concerns the unlocking of the locking device;
transmitting the request from the mobile device to the key management system; and
disabling the locking device by the key management.

10. The method according to claim 9, wherein the request is only stored in the digital vehicle key when direct communication between the motor vehicle and the key management is unsuccessful.

11. The method according to claim 9, wherein the request is stored in a mailbox of the digital vehicle key.

12. The method according to claim 10, wherein the request is stored in a mailbox of the digital vehicle key.

13. The method according to claim 9, wherein, in response to the request, the locking device existing on the motor vehicle is removed, wherein the locking device prevents processing of an attestation package for a newly generated digital vehicle key.

14. The method according to claim 10, wherein, in response to the request, the locking device existing on the motor vehicle is removed, wherein the locking device prevents processing of an attestation package for a newly generated digital vehicle key.

15. A control system device for a motor vehicle, the control system device comprising:
a device for communicating with a mobile device on which a digital vehicle key for the motor vehicle is stored; and
a processing device configured to store a request located in the digital vehicle key, which is directed from the motor vehicle to a key management system;
wherein the request relates to an unlocking of a locking device against addition of a newly generated digital vehicle key which can be used to control the motor vehicle.

16. A key management system for digital vehicle keys for a motor vehicle, the key management system comprising:
a device for communicating with a mobile device on which a digital vehicle key for the motor vehicle is stored; and
a processing device configured to read a request stored in the digital vehicle key which is directed from the motor vehicle to the key management system;
wherein the request relates to unlocking of a locking device against addition of a newly generated digital vehicle key which can be used to control the motor vehicle, and to disable the requested locking device.

17. A motor vehicle comprising a control device according to claim 7.

18. A motor vehicle comprising a control system device according to claim 15.

19. A system comprising:
a motor vehicle;
a control system device including
a device for communicating with a mobile device on which a digital vehicle key for the motor vehicle is stored; and
a processing device configured to store a request located in the digital vehicle key, which is directed from the motor vehicle to a key management system;
wherein the request relates to an unlocking of a locking device against addition of a newly generated digital vehicle key which can be used to control the motor vehicle; and
a key management system according to claim 8.
